(19) United States
(12) Patent Application Publication
(10) Pub. No.: US 2010/0191655 A1
(43) Pub. Date: Jul. 29, 2010

(54) REALITY GAME SHOW

(76) Inventor: Doron Porat CORN, New York, NY (US)

Correspondence Address: FULBRIGHT & JAWORSKI, LLP, 666 FIFTH AVE, NEW YORK, NY, 10103-3198, US

(21) Appl. No.: 12/703,291

(22) Filed: Feb. 10, 2010

Related U.S. Application Data
(63) Continuation of application No. 12/098,217, filed on Apr. 4, 2008, now abandoned.
Application No. 12/098,217 is a continuation-in-part of application No. 12/075,030, filed on Mar. 6, 2008, now abandoned.
(60) Provisional application No. 60/893,265, filed on Mar. 6, 2007.
(60) Provisional application No. 60/910,159, filed on Apr. 4, 2007.

(51) Int. Cl. G06Q 40/00; G06Q 50/00; G06Q 10/00

(52) U.S. Cl. 705/80; 705/35

(57) ABSTRACT

A program is provided in which individuals submit business proposals in efforts to receive funding or other support to be used to implement the proposals. The program may be provided distributed for television, internet, cellular telephones or other media.

### CROSS-REFERENCE TO RELATED APPLICATION

This application is based on and claims priority to U.S. Provisional Patent Application No. 60/910,159, filed on Apr. 4, 2007 and entitled REALITY GAME SHOW II, and is a continuation-in-part of U.S. patent application Ser. No. 12/075,030, filed on Mar. 6, 2008 and entitled REALITY GAME SHOW, which is based on and claims priority to U.S. Provisional Patent Application No. 60/893,265, filed on Mar. 6, 2007 and entitled REALITY GAME SHOW, the entire contents of all of which are hereby incorporated by reference.

### BACKGROUND

1. Field of the Invention

The present invention relates generally to entertainment and, more particularly, to integrating a multi-media entertainment program with capital investments.

2. Description of the Related Art

So-called “reality” television shows have recently increased in popularity, and continue to be produced in various formats. In a typical reality television show, people are portrayed as being in actual situations without reading from a script or performing fiction. Typically, the people on reality television shows are portrayed as not professional performers, but are instead common, everyday people.

Occasionally, even though a television programmed is billed as a “reality” television show, parties appearing on the program are instructed (or at least appear to be instructed) to behave or act according to a preset standard, thereby distancing the program's connection to reality. Also, parties appearing on the program often are selected on the basis of what is perceived as the parties' allure for the television audience. Further, situations are often provided in reality television programs that at least appear to viewers as contrived. This occurs, at least in part, due to editing techniques that provide content to suit a particular need, such as time constraints.

### SUMMARY

In accordance with a preferred embodiment, a program is provided in which individuals submit business proposals in efforts to receive funding or other support to be used to implement the proposals.

In one embodiment, a system and method is disclosed for providing a reality-based entertainment program. In particular, business proposals are received from participants, wherein the participants submit the proposals to receive funding to be used to implement the proposals. A host is provided who interacts with the participants and an audience on the program. Further, a financial provider reviews the business proposals, and selects at least one of the proposals based on the review. Funding is preferably provided by the financial provider to the at least one participant who submitted the selected proposal, and the funding is invested by the selected participant to develop the selected proposal. Further, the development of the participant's proposal is tracked over time.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is an illustration an example embodiment wherein a host is interviewing a potential participant in accordance with an embodiment;

FIG. 2 is an illustration wherein a participant is submitting a proposal to a group of potential investors around a conference table;

FIG. 3 is an illustration that shows a luxury yacht liner carrying the investors in accordance with an example embodiment;

FIG. 4 is an illustration of an example restaurant and bar owned by a participant and representing a successful investment outcome in accordance with a preferred embodiment;

FIG. 5 is an illustration of an example custom bicycle manufacturing and repair shop owned by a participant and representing another successful investment outcome in accordance with a preferred embodiment;

FIG. 6 illustrates an example hardware arrangement, in accordance with an example embodiment; and

FIG. 7 illustrates functional elements associated with an example information processor and/or user workstation in accordance with an embodiment.

### DESCRIPTION OF THE EMBODIMENTS

In one embodiment, an audio-visual production is provided that preferably integrates one or more financial instruments, such as short term loans, in order to find untapped new ideas within the world's population. Contestants preferably receive funding to develop their ideas into a working, successful business. Unlike typical reality television and entertainment programs, contestants preferably do not compete against each other, but merely work to succeed in developing their own respective business plans.

Participants preferably submit business proposals in hope of receiving funding or other support to develop their ideas into reality.

In one embodiment, a question is randomly posed to a group of people. One or more individuals of the group are preferably selected to send and/or receive a video interview and an application is submitted by the individual(s) that includes business plan, development papers or the like that represents how the individual(s) propose making money. A team of business or financial experts preferably reviews the application(s), and the individual(s) are selected to compete in the program in case an application is approved.

In an embodiment in which the program is broadcast on television, a television series is preferably developed and that is based upon the above-identified interview, and follows the financial adventures of the individual(s) selected. Preferably, the individual(s) are financed and implement a business plan substantially as set forth in the individual(s)' applications. The show is preferably hosted by a charismatic and/or famous or well-known celebrity and/or businessman, and includes steps typically associated with capital budgeting. For example, individual(s) who are selected as participants are provided with seed capital to finance a business. In a preferred embodiment, the television show is broadcast in various countries and, therefore, maintains an international quality.

The participants being financed are preferably measured by established average rates of return to receive additional capital. In other words, participants are not simply handed a significant amount of capital, such as one million dollars. Instead, participants must earn increases in capital by demonstrating success. Further, participants are restricted from spending seed money they receive in connection with the program on anything that is not related to and in the interest of promoting their ventures.

In an example embodiment, participants are provided with opportunity, guidance and capital, such as up to one million dollars, and use the money as best possible. Any idea that is deemed reasonable by the venture capitalists may be selected by a party seeking to participate. In this way, the program is alluring to viewers. For example, given correct guidance and financing, it is possible that a homeless man on the street has an idea that has enough potential that, if properly developed, can lead the man to be the next millionaire. It is further possible that this now can run a more successful business than a seasoned executive can.

In one alternative embodiment, the program causes businessmen who are randomly selected, for example, from major international cities, to compete against one another, thereby placing the parties into competition with their peers. In one other embodiment, participants may be unaware that they are competing against each other or even against someone unaffiliated with business, such as randomly selected person(s), such as groups of college students, high school students. The program, therefore, provides competition between virtually limitless kinds of people and from a wide variety of personal and professional backgrounds.

The various embodiments described and shown herein are preferably designed to educate and entertain an audience, simultaneously inspiring capitalist creativity from people around the world. Moreover, the program is a marketing vehicle for a gateway to financial freedom. In one embodiment, episodes may not be recorded or shown publicly, even though financial backing occurs.

Preferably, in worldwide, and especially in emerging markets the program of the present invention may utilize a form of micro-lending. For example, venture capitalists review and select options from among the best ideas uncovered throughout the world, and proper capital budgeting may be provided for a mutually beneficial relationship. Therefore and according to an embodiment, a significant amount of investment capital, such as one million dollars, may be portioned and provided for respective group efforts in an emerging market.

In one embodiment, advertising is provided in a context of target viewers. For example, a children's cereal box poses the question “What would you do with $1,000?” Further, the same form as marketing to kids in an ice cream store who have big dreams, while beer or alcohol companies, tobacco companies or the like will target a more “mature” audience. In this way, the present invention markets to as many future innovators, financial wizards and entrepreneurs as possible.

Talent may emerge in various ways. For example, in the creative arts, individuals may be selected for sculpting, cooking, painting, writing or performing music, or the like. Moreover, the internet and television media may be combined and serve as a way of exposing and marketing unique talent, such as by worldwide, matching buyers and sellers.

Thus an opportunity is provided for creative new emigrants to participate, making more money and paying more taxes, thereby strengthening an economy. Also, this is a chance for ethnic outreach by helping new emigrants attain the “American Dream.”

Thus, in accordance with an example embodiment, a combination of features, including financial instruments, capital investments, new business plans and entrepreneurial spirit and creativity, are merged into a multi-media production that is transmitted or broadcast across many platforms (e.g., television, radio and internet). This enables otherwise untapped ideas to be developed into successful business models, while simultaneously providing a revenue-generating entertainment program.

In an embodiment, a number of people are informed of an opportunity for financial investment in accordance with the teachings herein. An individual preferably receives an application, business plan, development papers, or the like, and submits a completed application and, optionally, a video interview for review. Applications are preferably reviewed by a team of business and/or financial experts. One or more of the experts may elect to invest in the individual's business plan. Alternatively, another group of investors, perhaps unrelated to a team that reviews the proposals and business plans, provides the revenue stream for the individuals.

In the video medium, a television series is preferably developed that is based on the interview process and that follows the financial adventures of the individuals. As noted above, the show is preferably hosted by a charismatic celebrity, perhaps a known and successful businessman, and preferably includes steps associated with capital budgeting. The individuals being financed are preferably measured against established average rates of return in order to receive additional capital, rather than provided with capital with no restrictions.

Preferably, participants are only given opportunity, guidance and capital, and are allowed to use the money as best they determine to develop any idea deemed reasonable by a group of people, such as venture capitalists.

As noted above, although the program is designed to educate and entertain the audience, in a grandiose way, it is also designed to inspire the capitalist creativity. Beyond this, the program is a marketing vehicle for a gateway to financial freedom, and many episodes may not be publicly shown, even though the financial backing can still completed.

Especially in emerging markets, the micro-loan model is employed and improved upon. Venture capitalists or their agents select from among the best ideas, and provide proper capital budgeting therefor in the interest of a mutually beneficial relationship. In an emerging market, perhaps $1M could be parsed into smaller amounts to support group efforts.

Advertising is preferably done in conjunction with companies with age-appropriate and proper contextual advertising. For example, a children's cereal box asks the question “What would you do with $1,000?” In the alternative, beer or alcohol companies, tobacco companies target a more mature audience. Additionally, talent is sought after within the creative arts (sculpting, cooking, painting, music, etc).

Preferably, various media (e.g., television, radio and the internet) operate to uncover and market unique talent such as the way EBAY matches buyers and sellers of goods. This offers, for example, a chance for creative new emigrants to the United States to participate, potentially earning more money and, accordingly, paying more taxes. Also, this is a chance for an ethnic outreach, by helping new emigrants attain the “American Dream.” Further, the teachings herein provide a chance for a rehabilitation such as for those struggling with addiction, is mentally or physically challenged, a single parent or the like. There is preferably no prejudice against race, color, creed, religion, or the like.

In an embodiment, a voice over (“V/O”) shows people living other people's dreams (image is provided showing menial labor). Some people believe success is impossible. So what is the secret? How is one person a success and the other a dreamer?

As shown and described herein, capital and a boardroom of business experts are provided to help a participant succeed. The program preferably tracks the success or failure of those who can answer the question “what would YOU do with a million dollars?”

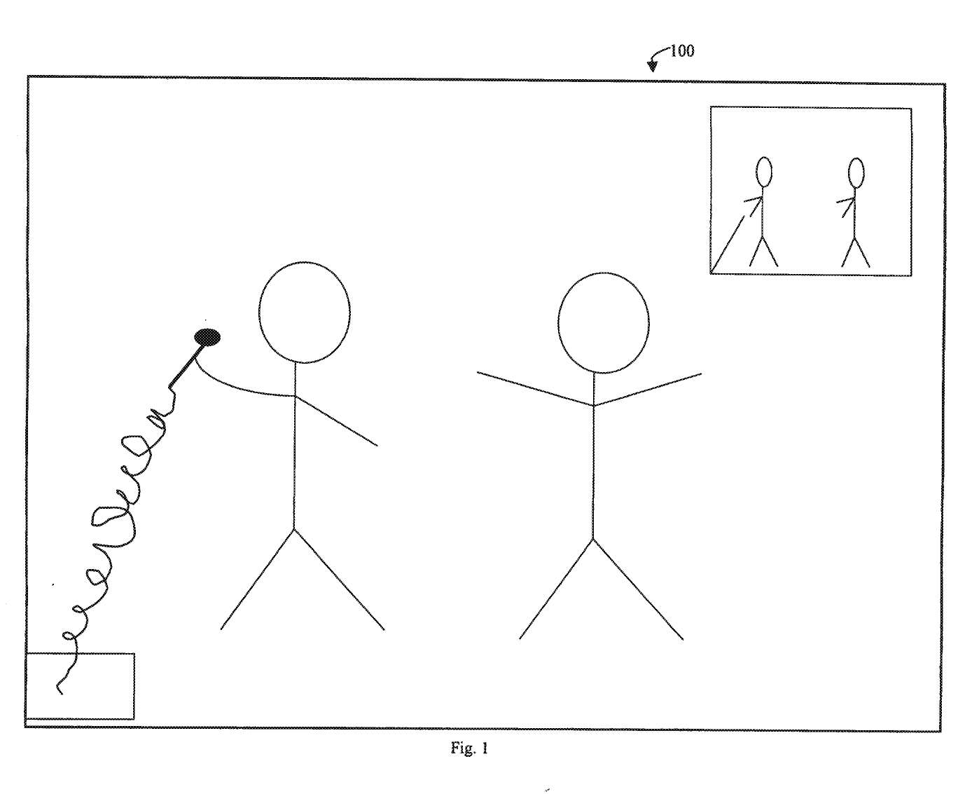

Examples of an embodiment are shown in FIGS. 1-5. The examples shown in FIGS. 1-5 are exemplary episodes and business plans that are developed in connection with episodes broadcast on television or shown on the internet. In FIG. 1, an example introduction 100 of a participant is shown. An initial discussion with a participant with a host for viewing audience is provided, including images/video introducing a participant and showing the participants life as it is as of the time of the introduction.

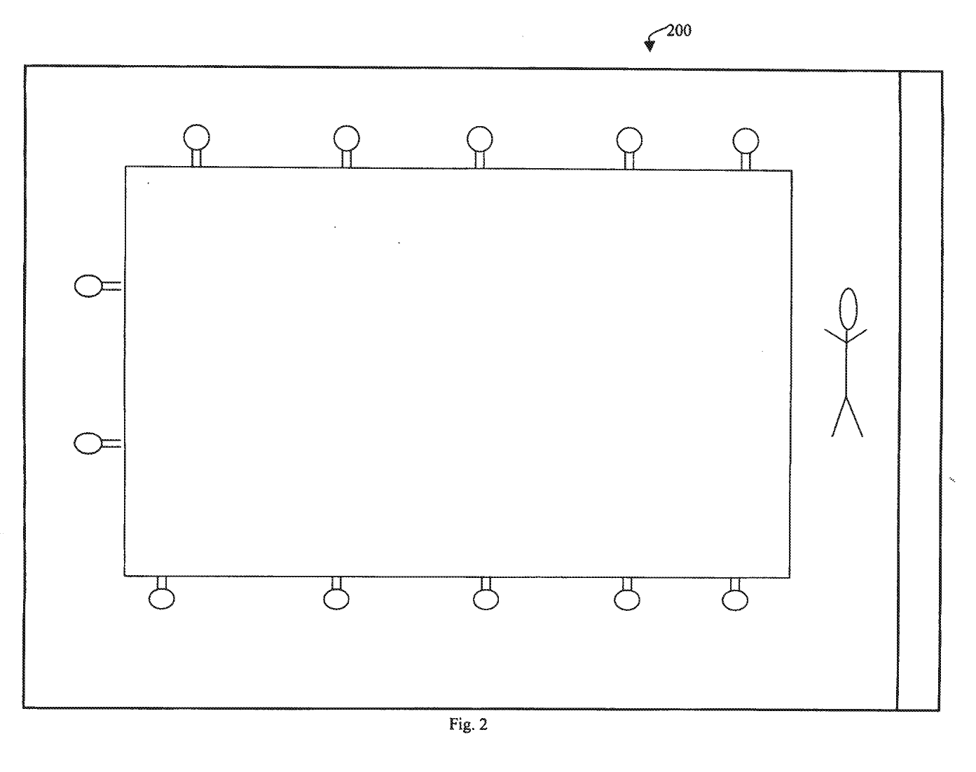

Continuing with the reference to the figures, an introduction 200 to the board is shown in FIG. 2 that includes elitist, goals of extreme wealth. For example, luxury cars pick up a participant with the host and take them to the board of financial providers. The program preferably portrays a dichotomy between various classes, including high profile office space, and luxurious amenities give viewing audience an impression of having intimate insight into interactions and exposures to various parties.

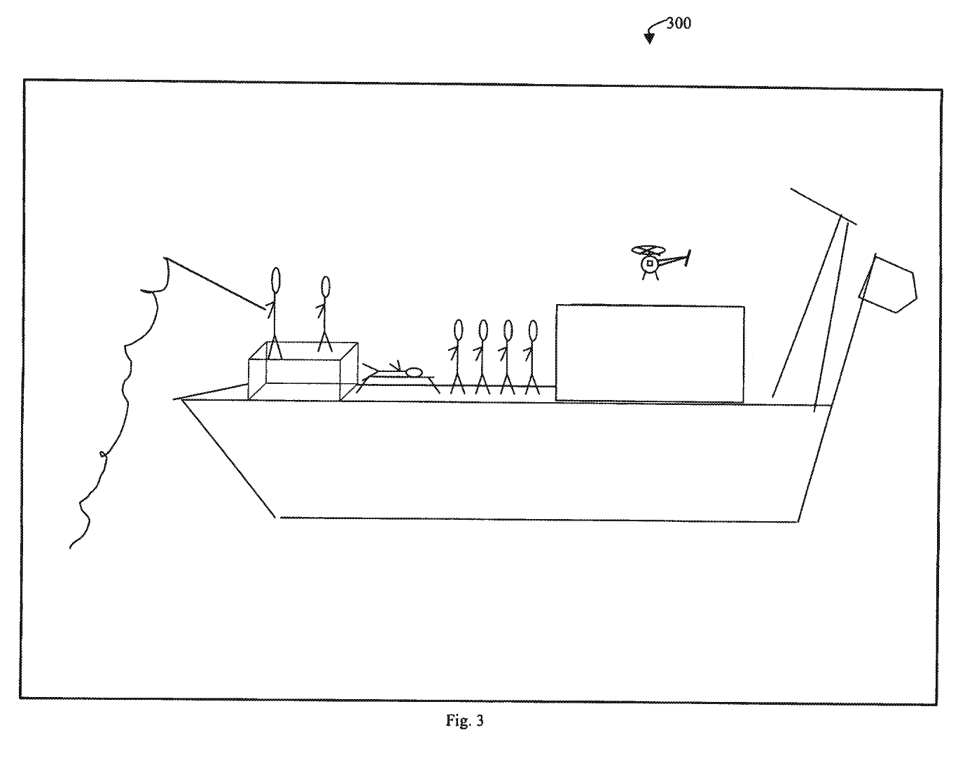

Further the viewing audience is provided with a glimpse into extreme wealth and luxury, thereby making the unattainable appear within reach. For example, a scene 300 depicts a helicopter picking up a participant with the host and landing on a luxury yacht (FIG. 3). And the host, who preferably seems aligned more with participants, has at his disposal a seemingly limitless amount of wealth and resource. Host preferably shows subtle elements of sarcasm as he interacts selectively with the viewing audience, making occasional remarks about members of the board, developing a sense of us versus them.

Moreover, the board appears aloof and grudgingly responsive to participants, even though its ultimate goal is to make money. Also, friendly and not-so-friendly bantering between board members occurs. Capital is preferably generated by television sponsors.

Further, the program preferably maintains an appeal across economic strata. For viewers, an attraction to those with wealth, and those longing for wealth, alike are drawn to the program. One communication technique is to attract the less sophisticated in order to gain greater appeal. Participants may have raised some capital on their own, thereby demonstrating a degree of seriousness.

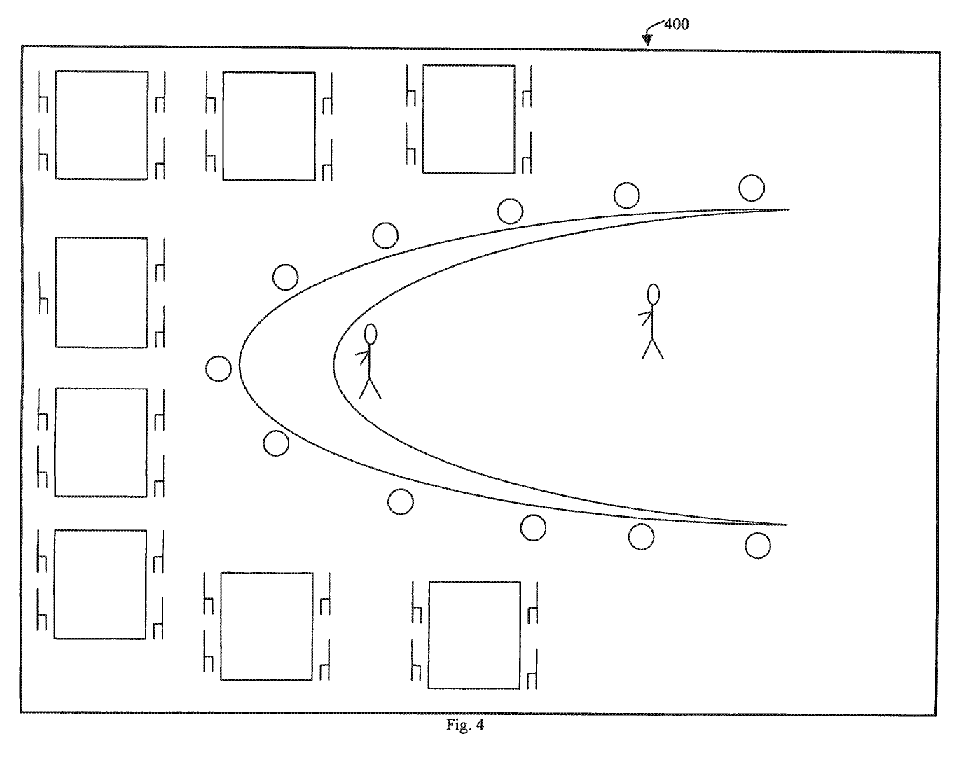

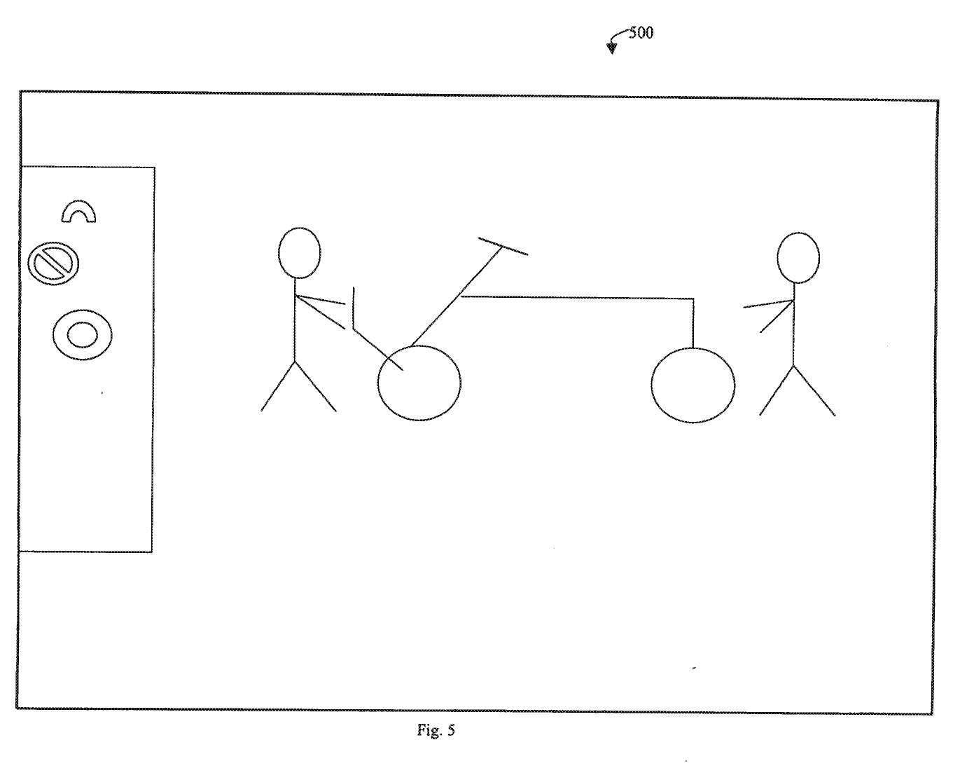

In one example episode, a participant has an idea 400 for a restaurant/bar in a location (FIG. 4), and seeks $100,000. Another participant has an idea 500 to open a custom bicycle shop for repair and manufacture (FIG. 5). Another has an idea to open book carts on the streets. In another episode, a participant fails by not keeping a meeting (delayed by cab/plane, etc.).

Further the program preferably includes an element of ruthlessness of real business. After a few participants have been established, introduced and developed, the program increases its alternating focus between them. A real-world example business element showing participants investing earnings and/or investing loans back into their respective businesses. Thus, the program maintains an appearance of reality that exceeds typical prior art reality-based television programs.

Alternative embodiments are preferably envisioned herein. For example, business proposals that are not accepted to be funded in connection with the program may nevertheless be marketed to public venture capitalists, money-lending institutions, micro-loan financiers or the like, or the general public. Video clips or other proposals that are submitted by potential participants can be archived and presented in a public forum, such as on a web site. Parties who wish to purchase or otherwise fund proposals submitted by potential participants (or actual participants) may fund the proposals themselves, or may find alternative sources of revenue or interest in a proposal in order to subsidize a proposal and seek financial gain for the investor. In this way, a marketplace of ideas can be implemented in a matching of buyers, funders and sellers of business plans, ideas and ventures.

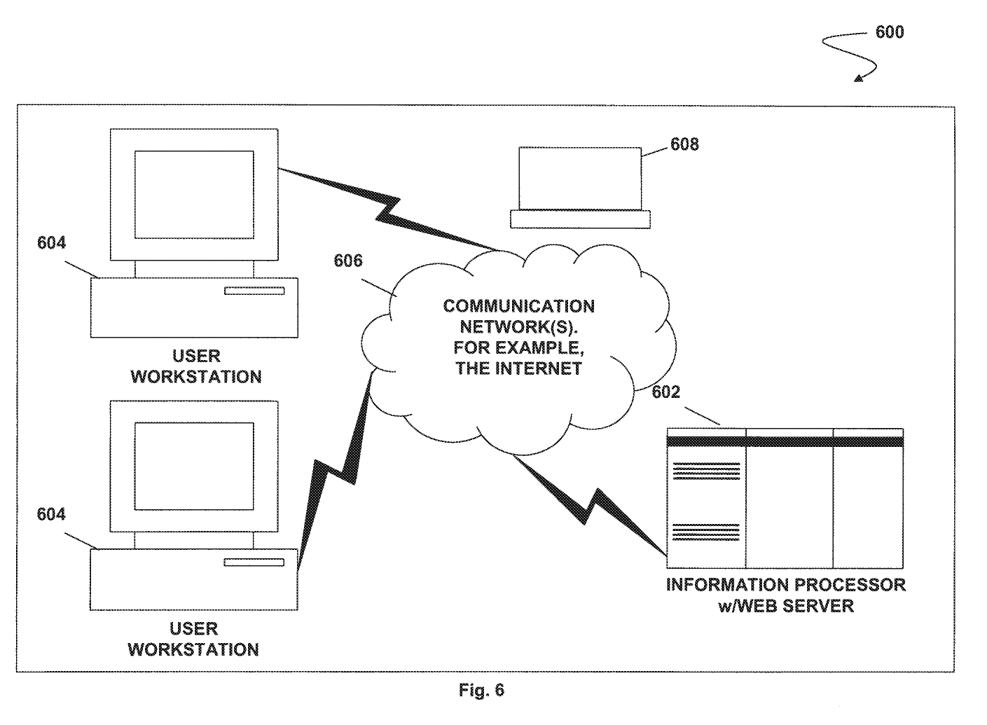

FIG. 6 illustrates an example hardware arrangement, in accordance with an embodiment providing a program via broadcast, direct cable connection or over a communication network, and referred herein, generally, as system 600. In the example shown in FIG. 6, information processor(s) 602 preferably include all databases necessary to support the present invention. However, it is contemplated that information processor 602 can access any required database via communication network 606 or any other communication network to which information processor 602 may be coupled. Workstations 604 preferably communicate with information processors 602 via communication network 606. Communication network 606 is preferably a global public communication network such as the Internet, but can also be a wide area network (WAN), local area network (LAN), an intranet or other network that enables computing devices and peripheral devices to communicate.

In a preferred embodiment, information processor 602 is any computer readable medium device that is capable of sending and receiving data across communication network 606, e.g., mainframe computers, mini computers, personal computers, laptop computers, a personal digital assistants (PDA), cellular telephones and Internet access devices such as Web TV. In addition, information processors 602 are preferably equipped with web browser software, such as MICROSOFT INTERNET EXPLORER, MOZILLA FIREFOX, or the like. Information processors 102 are coupled to communication network 606 using any known data communication networking technology.

Also shown in FIG. 6 is television 608 that is preferably operable to receive television broadcast signals (digital and/or analog), for example, via communication network 606 or via cable access.

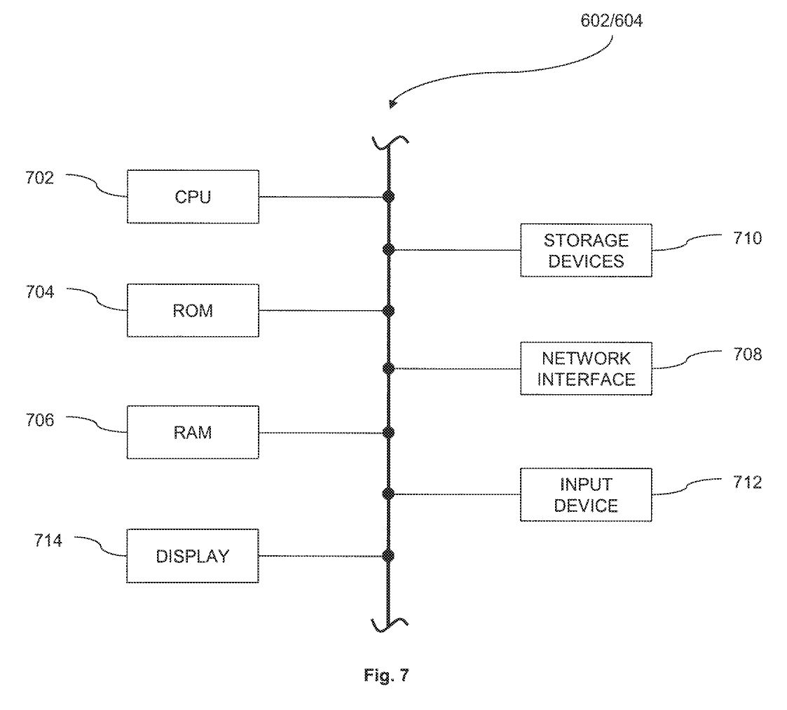

FIG. 7 illustrates the functional elements of an example information processor 602 and/or workstation 604, and includes one or more central processing units (CPU) 702 used to execute software code and control the operation of information processor 702. Other elements include read-only memory (ROM) 704, random access memory (RAM) 706, one or more network interfaces 708 to transmit and receive data to and from other computing devices across a communication network, storage devices 710 such as a hard disk drive, floppy disk drive, tape drive, CD ROM or DVD for storing program code databases and application data, one or more input devices 712 such as a keyboard, mouse, track ball, microphone and the like, and a display 714.

The various components of information processor 702 need not be physically contained within the same chassis or even located in a single location. For example, storage device 710 may be located at a site which is remote from the remaining elements of information processor 602, and may even be connected to CPU 702 across communication network 606 via network interface 708. Information processor 602 preferably includes a memory equipped with sufficient storage to provide the necessary databases, forums, and other community services as well as acting as a web server for communicating hypertext markup language (HTML), Java applets, and Active-X control programs. Information processors 602 are arranged with components, for example, those shown in FIG. 7, suitable for the expected operating environment of information processor 602. The CPU(s) 702, network interface(s) 708 and memory and storage devices are selected to ensure that capacities are arranged to accommodate expected demand.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL and PHP.

Although the present invention is described by way of example herein and in terms of a television-based and/or web-based system using web browsers and a web site server (e.g., information processor 602), system 600 is not limited to such a configuration. It is contemplated that devices 602, 604 and 608 communicate using any known communication method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 602, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

In an alternative embodiment, an internet, web-based venue is preferably provided for various parties, such as viewers, potential candidates, and micro-finance applicants to showcase their ideas. In this embodiment, ideas are preferably provided for consideration for financing in accordance with micro-loan and/or micro-finance processes. If an idea is unwanted or deemed impractical, the idea will either be discarded or placed in a type of idea marketplace for review by visitors to the venue. If there is no interest in an idea, then the idea is preferably available for sale to venture capitalists. Preferably, a transactional fee is earned as a function of the sale. In case there is interest in an idea then the provider of the venue may have a right of first refusal to fund or otherwise support development of the idea. In this way, a “Web 2.0” embodiment, as known in the art, offers micro-finance applicants a chance to showcase ideas in a widely available medium, as well as to save an application and update progress in connection with realization of capital funding to develop the idea.

Preferably, this alternative embodiment operates separately from, or in conjunction and concurrently with a broadcast television show, as shown and described above. In the web-based media format of this alternative embodiment, an Internet-based video production, i.e., television for the Internet is provided. By implementing this embodiment on the internet, a large number of applications can be received and processed through a company with specialized technology to glean, summarize, categorize and organize the multitude of incoming ideas. The availability to send and receive many ideas is integral in taking the micro-finance schematic to a larger marketplace.

Preferably and in addition to economic wealth, the teachings herein also focus on social and spiritual wealth. In particular, parties who may be disadvantaged, such as economically, socially, or physically, use the teachings herein enable participants to realize an opportunity to achieve social change.

Although the present invention is described and shown in relation to particular embodiments thereof, many other variations and modifications and other uses will become apparent to those skilled in the art. It is preferred, therefore, that the present invention be limited not by the specific disclosure herein.

1-20. (canceled)

21. A system for providing an entertainment program over a communications network, comprising:
a processor based server to receive business proposals from a plurality of web enabled devices over said communications network, each web enabled device being associated a participant;
a storage device to store said business proposals received by said processor based server from said plurality of web enabled devices; and
a computer associated with a financial provider to receive said business proposals from said processor based server, the financial provider reviewing said business proposals and selecting at least one business proposal for funding; and
wherein said processor based server receives over said communications network and stores said at least one business proposal selected for funding and terms of the funding from said computer associated with the financial provider in said storage device; and
wherein said processor based server transmits over said communications network the terms of the funding to a web enabled device associated with a participant who submitted a proposal selected for funding by said financial provider.

22. The system of claim 21, wherein said processor based server transmits said business proposals to a plurality of computers over said communications network, each computer being associated with a different financial provider.

23. The system of claim 21, wherein each of said plurality of web enabled device is one of the following: a computer, a PC, a laptop, a personal digital assistant, a cell phone, or a Web TV.

24. A method for providing an entertainment program over a communications network, comprising the steps of:
receiving business proposals from a plurality of web enabled devices over said communications network by a processor based server, each web enabled device being associated a participant;
storing said business proposals received by said processor based server from said plurality of web enabled devices in a storage device; and
transmitting said business proposals to a computer associated with a financial provider over said communications network by said processor based server, the financial provider reviewing said business proposals and selecting at least one business proposal for funding;
receiving said at least one business proposal selected for funding and terms of the funding from said computer associated with the financial provider over said communications network by said processor based server;
storing said at least one business proposal selected for funding and terms of the funding received from said computer associated with the financial provider in said storage device; and
transmitting over said communications network the terms of the funding to a web enabled device associated with a participant who submitted a proposal selected for funding by said financial provider.

25. A computer readable medium comprising computer executable instructions for:
receiving business proposals from a plurality of web enabled devices over said communications network by a processor based server, each web enabled device being associated a participant;
storing said business proposals received by said processor based server from said plurality of web enabled devices in a storage device; and
transmitting said business proposals to a computer associated with a financial provider over said communications network by said processor based server, the financial provider reviewing said business proposals and selecting at least one business proposal for funding;
receiving said at least one business proposal selected for funding and terms of the funding from said computer associated with the financial provider over said communications network by said processor based server;
storing said at least one business proposal selected for funding and terms of the funding received from said computer associated with the financial provider in said storage device; and
transmitting over said communications network the terms of the funding to a web enabled device associated With a participant who submitted a proposal selected for funding by said financial provider.
